(19) United States
(12) Patent Application Publication
(10) Pub. No.: US 2017/0105418 A1
(43) Pub. Date: Apr. 20, 2017

(54) High-Load Pyrethroid Encapsulated Seed Treatment Formulations

(71) Applicant: FMC Corporation, Philadelphia, PA (US)

(72) Inventors: Laibin Bruce Yan, North Wales, PA (US); John E. Kibbee, Guelph (CA); Roderick G. McLeod, Lethbridge (CA); William M. Scherzinger, IV, Jackson, NJ (US)

(21) Appl. No.: 15/119,585

(22) PCT Filed: Feb. 19, 2015
(86) PCT No.: PCT/US15/16585

§ 371 Date: Aug. 17, 2016

Related U.S. Application Data
(60) Provisional application No. 61/941,943, filed on Feb. 19, 2014.

(51) Int. Cl. A01N 53/00; A01N 25/28

(52) U.S. Cl. CPC A01N 53/00; A01N 25/28

(57) ABSTRACT

An insecticide composition comprising a plurality of microcapsules wherein each microcapsule comprises an outer polymeric shell encapsulating a core containing pyrethroid.

### CROSS-REFERENCE TO RELATED APPLICATIONS

This application claims the benefit of priority of U.S. Provisional Application No. 61/941,943 filed on Feb. 19, 2014, the disclosure of which is incorporated herein by reference in its entirety.

### FIELD OF THE INVENTION

The present invention relates to the field of agrochemical compositions and formulations. In particular, the invention provides an insecticidal formulation comprising capsules of micron size or nanosize and a process for their production for use as a seed treatment.

### BACKGROUND OF THE INVENTION

It is important to treat crop plants, grass and turf with crop protection agents in order to control pest-induced damage to the crops, grass or turf. The use of microcapsules for both the slow or controlled and fast or quick release of liquid, solid and solids dissolved or suspended in solvent has been described in the pharmaceutical, specialty chemical and agricultural industries. In agriculture, these release techniques have improved the efficiency and delivery of active agents.

In general, the diffusion of entrapped material is a function of the capsule wall and its porosity as well as the effects of the surrounding medium and environment. Accordingly, microcapsules may be designed to controlled release the material to the surrounding medium by modifying the cross-linkage in the wall or follow a delayed or controlled release pattern. In addition, the microcapsule wall can serve as a barrier to disperse water-immiscible liquids into water medium for ease of delivery. As such, the microencapsulated active ingredients provide substantial benefits in controlling the outcome in agricultural plans.

However, at least one shortcoming in the art of preparing microcapsules involves inferior loading capacity. In other words, effective amounts of an active ingredient may not be easily encapsulated to provide its intended use. Typically, low loading of the active ingredients does not support the economics for preparing microencapsulated insecticides. Thus, there continues to be a need for more effective methods of loading insecticides in microcapsule formulations. On the other hand, high loading of actives would normally increase toxicity level of the product and hence move the regulatory label to undesired catalogs.

Seed compositions for agricultural crops are also known. Many seed treatments, however, are based upon compositions that have certain undesirable attributes, and in modern day farming might be termed as environmentally unsatisfactory. For example, compositions that contribute to runoff causing environmental problems such as eutrophication of groundwater, nitrate pollution, phosphate pollution and the like are unsatisfactory. On another hand, ineffective active ingredient loading, high manufacturing cost and damaging seed treatment equipment are among concerns among different players in the industry.

The prior art even when combined has not provided those of ordinary skill in the art with any useful information in preparing the innovative formulation to address the industry concerns, nor has it suggested an effectiveness of formulations that are surprisingly superior from available combinations and seed treatment options. The present invention is directed to meeting this need and overcoming the dilemma facing the industry.

### SUMMARY OF THE INVENTION

The present invention is directed to an insecticidal composition, particularly a liquid insecticidal material that is encapsulated by a polymeric shell providing a number of advantages as compared to its prior art counterparts. Further, this invention relates to the processes for the production of such microcapsules, including intermediate processes, and methods for their use. While not wishing to be bound by any theory, another aspect of the invention is to provide seed treatment composition that can address the shortcomings in the art.

In one aspect of the invention a microcapsule is described that contains a polymeric wall encapsulating an active insecticide. In this embodiment, the microcapsule contains shell(s) either in a multilayer or a unilayer design. The outer polymeric shell contains at least one polymer that can be biodegradable. In at least one embodiment, the polymeric shell contains a polymer selected from the group consisting of polyurea, polyurethane, polyamide, polyester, and the like.

At least another aspect of the present invention describes a liquid agricultural formulation containing a plurality of microcapsules encapsulating a pyrethrin or synthetic pyrethroid insecticide in a suitable solvent. In one embodiment, the insecticide is a pyrethroid selected from the group consisting of bifenthrin, zeta-cypermethrin, alpha-cypermethrin, permethrin, lambda-cyhalothrin, and tefluthrin. In a more preferred embodiment, the insecticide is bifenthrin. In another embodiment, the invention is directed to a plurality of microcapsules wherein each microcapsule comprises an outer polymeric shell encapsulating a liquid or solid core containing bifenthrin. In another embodiment, the formulation further contains a solvent, a co-solvent, an oil, an emulsifier, a viscosity modifier agent, an antifoam agent, an amine and a pH modifier.

In another aspect of the invention, the microcapsules have a diameter size ranging between 0.1-500 μm. In a more preferred embodiment, at least 90% of the microcapsules in the formulation have a diameter ranging from 0.5 to 50 μm. In another embodiment 90% of the microcapsules have the diameter in the ranges of 1 to 50 μm.

Another aspect of the present invention includes methods of providing high load and high efficacy insecticide formulations. In accordance with another embodiment of the present invention, the inventors have developed compositions useful for delivery of substantially water-soluble or water-insoluble insecticides in combination with other active ingredients selected from the group consisting of a, arthropodicide, insecticide, miticide, acaricide, nematocide, fungicide, selective herbicide, plant growth regulator or a combination of two or more of these biological activities.

Another aspect of the invention is directed to process of making a high-load insecticide containing microcapsule compositions. In at least one embodiment, the high-load insecticide microcapsules are prepared by the steps of (a) mixing agrochemical with an organic solvent, at least one monomer, and an oil to prepare an organic mixture phase, (b) dissolving effective amounts of an emulsifier, polyvinyl alcohol, and a thickener in an aqueous solvent to form an aqueous phase, and (c) homogenizing the organic phase with the aqueous phase in a homogenizer, and (d) allowing interfacial polymerization for a sufficient period of time. In a more preferred embodiment, the interfacial polymerization occurs at a temperature ranging from 25° C. to about 65° C.

In another aspect of the present invention, the microcapsule compositions of the present invention can be directly applied to a seed as a seed treating composition thereby unexpectedly produce significantly higher crop yield as compared to other seed treatment compositions. Such crops may include wheat, corn, barley, beans, cereals, citrus, cocoas, coconuts, coffee, corn, cotton, fiber crops, flowers, forge corps, forestry, groundnuts, peanuts, hops, horticultures, non-land crops, oil palm, oilseed rape, peas, pomes, potato, rice, stonefruit, spices, sugar cane Sunflower, tea, tobacco, tomatoes, tree nuts, turf, vegetable crops, vines, and grapes and the like.

### BRIEF DESCRIPTION OF THE FIGURES

FIGS. 1 (A)-(D) are Example SEM images of microcapsules of Bifenthrin CS formulations.

FIGS. 1 (E)-(F) are Example SEM images of microcapsules of Bifenthrin CS formulations on treated corn seeds.

FIG. 1 (G) is an Example SEM image of microcapsules of Bifenthrin CS formulations on treated wheat seeds.

FIGS. 2 (A)-(B) are photographs of corn seeds treated with high loading bifenthrin CS formulation (left) and with bifenthrin SC formulation (right).

FIGS. 3 (A)-(B) are photographs of wheat seeds treated with high loading bifenthrin CS formulation (left) and with high loading bifenthrin SC formulation (right).

FIGS. 4 (A)-(B) show the drum surface of Hege treater after treating wheat seeds with high loading bifenthrin CS formulation (left) and high loading bifenthrin SC formulation (right).

FIGS. 5 (A)-(B) show the drum surface of Hege treater after treating corn seeds with high loading bifenthrin CS formulation (left) and high loading bifenthrin SC formulation (right).

FIG. 6 provides the biological field trial data displaying the Plant Counts versus treatment.

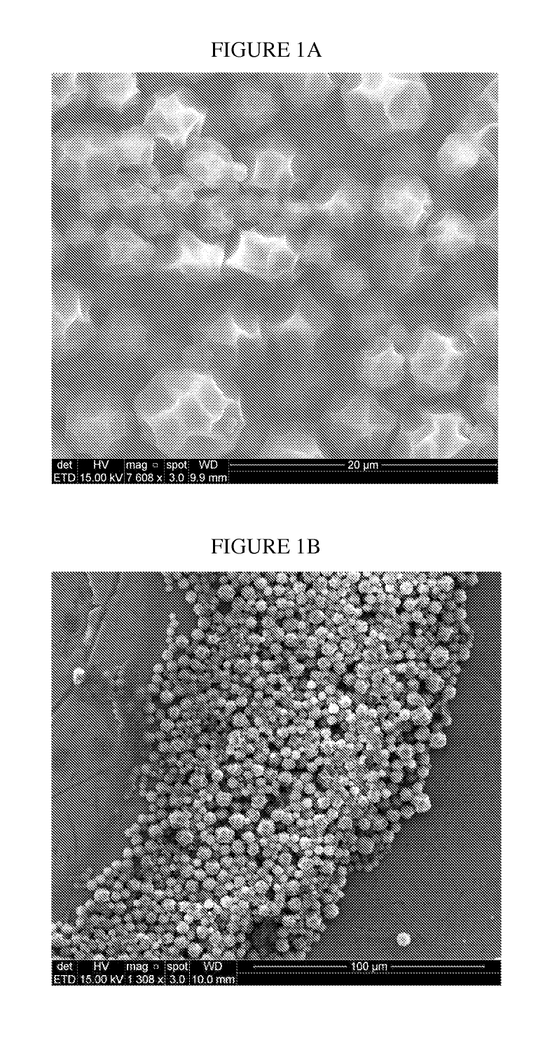

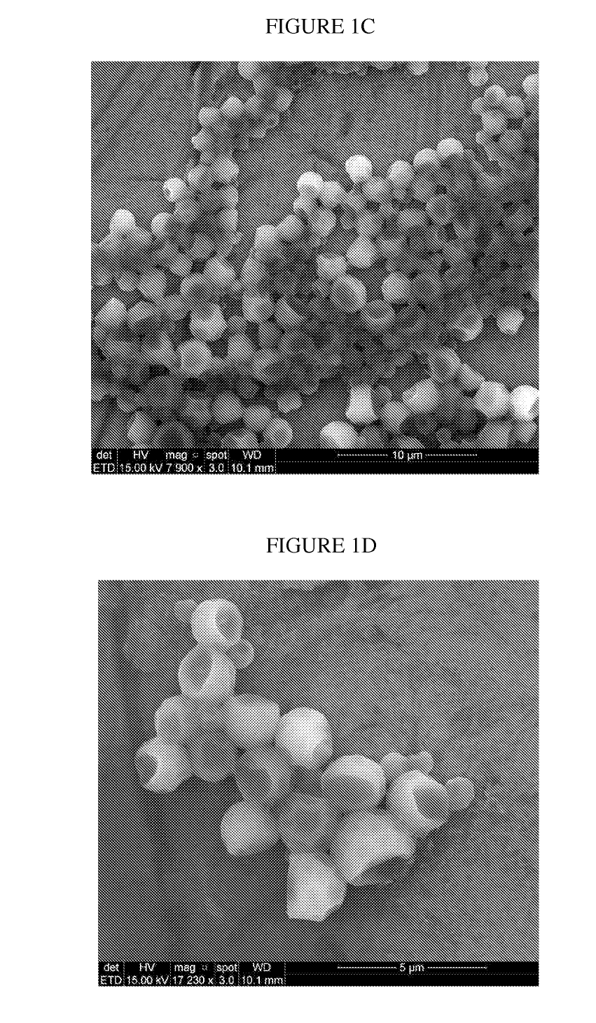

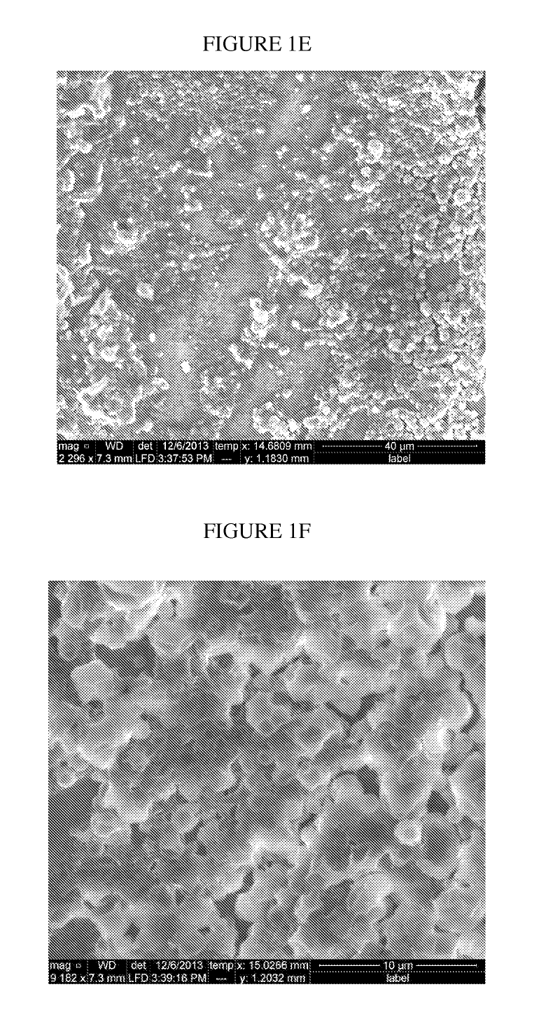

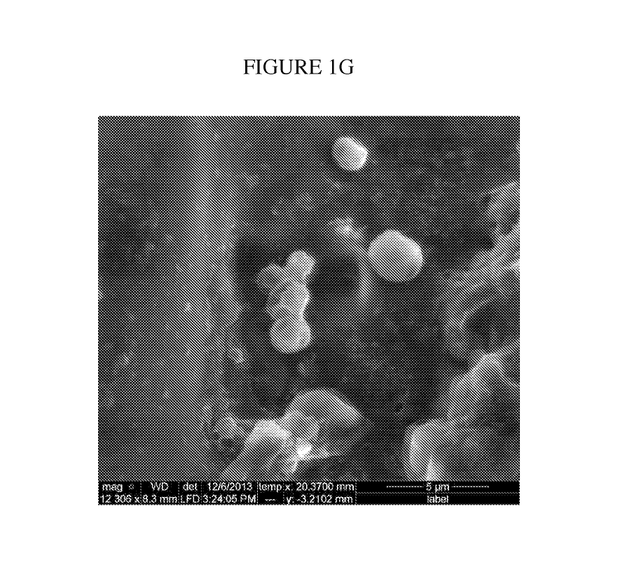

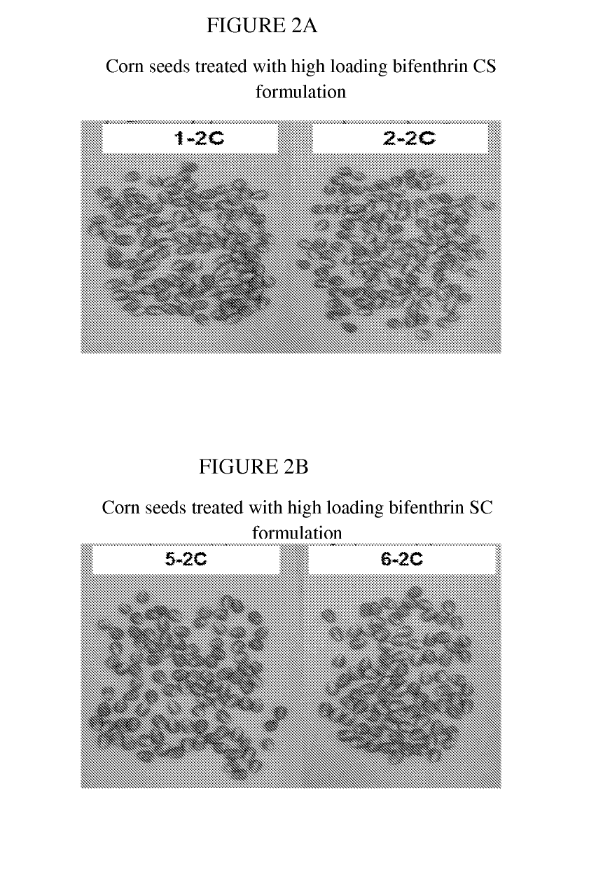

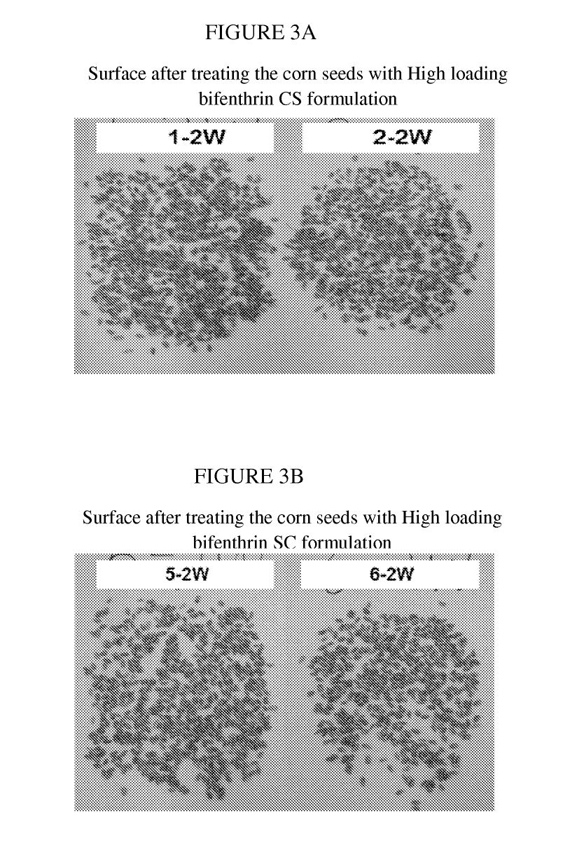

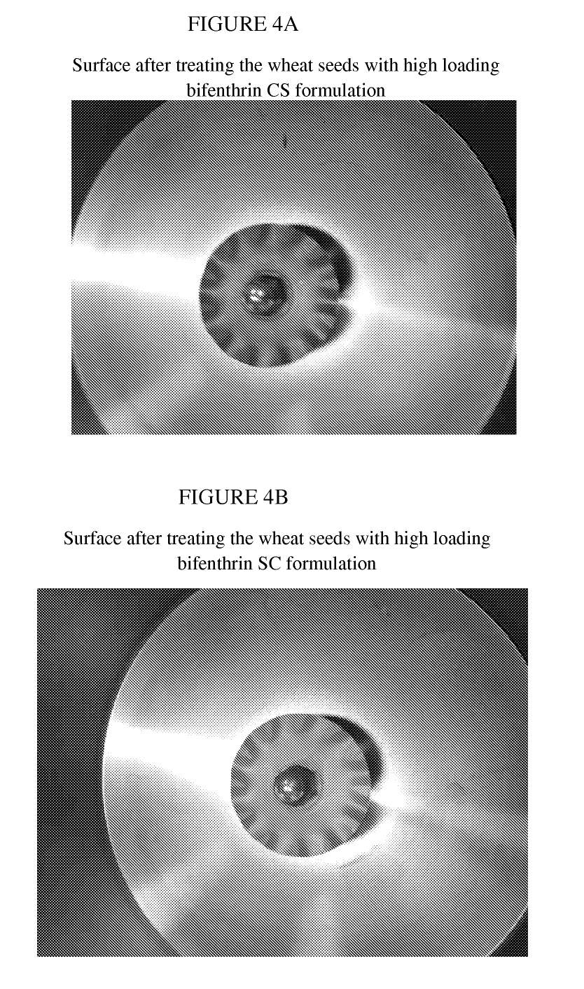

### DETAILED DESCRIPTION OF PREFERRED EMBODIMENTS

The present disclosure meets the needs for a high loading insecticide microencapsulation formulation for crop treatment. Accordingly, high-precision application of agricultural active ingredients is described by providing a formulation capable of delivering at least 5 to 48 times more active ingredients to a site of interest. The present invention describes insecticide compositions for delivery of water-insoluble active agents contained within a microcapsule having a polymeric shell. The polymeric shell can be a biodegradable polymer optionally crosslinked in the presence of crosslinking agent. In one embodiment, the microcapsule contains substantially water-insoluble insecticide compounds which are suspended as an oil-in-water emulsion.

The term “microcapsule,” as used herein, refers to a spherical microparticle consisting of a polymeric shell serving as a wall-forming material and an encapsulated active substance located within the shell. This term is distinct from other spherical granules of the active substance dispersed in solvent or a polymer. The microcapsules of the present invention can consist of a single polymeric shell, or be a unilayer wherein the active substance is located within the inner core or center of the microcapsule. The microcapsules of the present invention can also refer to a “multilayer microcapsule” which consisting of an inner core microcapsule and one or more outer polymeric shells. In either case, the microcapsules of the present invention have a diameter ranging from 0.1 micron to 500 microns.

As used herein the term “wall-forming polymer” refers to a polymer or polymerizable monomeric units or a combination of two or more different polymers or polymerizable monomeric units, which form a component of the external wall or layer or shell of the microcapsules.

The term “polymer shell” refers to a layer containing the wall-forming polymer and, optionally, other components such as a plasticizer, oil, pore forming components and/or a mineral.

One aspect of the invention is directed to a microcapsule containing a polymeric shell encapsulating an insecticide. A second aspect of the invention is directed to a microcapsule that contains (a) a pyrethroid, (b) an oil or solvent, and (c) at least another active ingredient.

In another aspect of the invention, the formulation comprises a plurality of microcapsules, wherein at least one population of microcapsules has an effective particle size (“D90”) of less than about 500 microns; in another embodiment D90 is less than about 100 microns, and yet in another embodiment, D90 is up to or less than 20, 18, 15, or 10 microns. In a specific embodiment the microcapsules population has a particle size defined by D90 of between about 1 and about 7 microns, preferably between 2-6 microns.

In another embodiment, each microcapsule in the above mentioned population of microcapsules is composed of (a) an insecticide, (b) one or more oil component, and (c) one or more viscosity modifiers. In at least one embodiment, viscosity modifiers are included to help prevent settling of the capsules and other suspended components. Selection of viscosity modifiers is known to those skilled in the art and can include a wide variety of components including but not limited to attapulgite clays, xanthan gums, and modified cellulose derivatives. In the more preferred embodiment each microcapsule contains bifenthrin. In one embodiment, the ratio of bifenthrin is loaded in amounts of up to 480 grams in one liter or about 50% higher than conventional microencapsulated formulations. In another embodiment, the viscosity of the final product is adjusted to a measurement ranging from 200 and to 5000 Centipoises (mPa·s) with spindle #3, measured with Brookfield LVT Rotational Viscometer.

In one embodiment of the invention, the insecticide in total is present in about 0.1% to about 50% by weight of the total formulation. In another embodiment the viscosity modifier is present in about 0.01 to about 15 percent by weight of the total formulation.

At least one aspect of the present invention is directed to the solid permeable shell prepared from a polymer made by isocyanate polymerization. In one embodiment, the polymerization is facilitated by a surface modifying compound that reacts with the isocyanate moiety. Suitable isocyanates include but are not limited to aromatic isocyanates such as isomers of toluene diisocyanate, isomers and derivatives of phenylene diisocyanate, isomers and derivatives of biphenylene diisocyanates, polymethylenepolyphenyleneisocyanates (PMPPI), polymethylene polyphenyl isocyanate containing 4,4′ Methylene bisphenyl isocyanate, aliphatic acyclic isocyanates such as hexamethylene diisocyanate (HMDI), cyclic aliphatic isocyanates such as isophoronediisocyanate (IPDI) and trimers of HMDI or mixtures thereof.

Other polymers, either biodegradable or non-biodegradable, may also be employed in the structure of the microcapsule shell. They include synthetic cellulose or other cellulose moieties such as cellulose acetate butyrate, cellulose acetate phthalate, carboxylethyl cellulose, cellulose triacetate, and cellulose sulphate sodium salt, polymers of acrylic acid, methacrylic acid or copolymers or derivatives thereof including esters, poly(methyl methacrylate), poly(ethyl methacrylate), poly(butylmethacrylate), poly(isobutyl methacrylate), poly(hexylmethacrylate), poly(isodecyl methacrylate), poly(lauryl methacrylate), poly(phenyl methacrylate), poly(methyl acrylate), poly(isopropyl acrylate), poly(isobutyl acrylate), and poly(octadecyl acrylate), polyacrylic acids, poly(butyric acid), poly(valeric acid), and poly(lactide-co-caprolactone), copolymers and blends thereof.

Examples of non-biodegradable polymers include ethylene vinyl acetate, poly(meth)acrylic acid, polyamides, copolymers and mixtures thereof. Examples of biodegradable polymers include polymers of hydroxy acids such as lactic acid and glycolic acid polylactide, polyglycolide, polylactide co glycolide, and copolymers with PEG, polyanhydrides, poly(ortho)esters, polyurethanes, poly(butyric acid), poly(valeric acid), and poly(lactide-co-caprolactone).

In at least one embodiment, the microcapsules of the present invention are designed to release core material slowly over a period of time or may be sufficiently robust or to be dried and then re-dispersed. In general it is preferred that the weight ratio of the wall material to the microcapsule (core plus wall) is greater than 1% by weight. Typically the weight ratio will be from 1% to 70% or more specifically from 3% to 15%.

In another embodiment, the formulation of the present invention contains pore forming material that would allow permeation of the insecticide out of the microcapsules. In one embodiment, isocyanate can react with an amine moiety to form a polyurea or with a di- or tri-glycol to form a polyurethane. The isocyanate molecules are usually contained within the oil phase in the processes described herein. The amino groups may be generated in the oil phase or at the oil-water interface. Cross-linking may be accomplished by the inclusion of a cross-liner such as acetic acid ethenyl ester.

In another embodiment, polyurea microcapsules are described. In at least one embodiment, the shell of microcapsules is of polyurea formed via emulsion polymerization process and cross-linked with acetic acid ethenyl ester. In at least one embodiment, the wall-forming reaction is initiated by heating the emulsion to an elevated temperature at which point some isocyanate groups are hydrolyzed at the interface to form amines, which in turn react with unhydrolyzed isocyanate groups to form the polyurea microcapsules.

In at least one embodiment, the microcapsules are prepared in such manner to provide a microcapsule shell thickness ranging from 5 nanometers to 1000 nanometers. In a more preferred embodiment, the microcapsule has a shell wall thickness ranging from 10 to 200 nanometers, alternatively 15-100 nanometers resulting in microcapsules thereby reducing the amount of buildup on the treating equipment.

In at least another embodiment, the polymerization reaction is allowed to proceed so as to form a microcapsule wall thickness that is suitable for the present intended purpose. In one embodiment, altering the concentration of the polymeric isocynate in the oil phase and its respective ratio to the amine moiety can lead to different wall thickness. For example, in at least one example, when the concentration of polymethylene polyphenyl isocyanate containing 4,4′ Methylene bisphenyl isocyanate (PAPI® 27) is 3.9% in the oil phase and the amine to PAPI® 27 ratio is 0.89 to 1.0 respectively, then the wall thickness of the resulting microcapsules are much less as compared to a scenario where PAPI® 27 is present in amount of 7.5% in the oil phase. Similarly, altering the amine: PAPI® 27 ratio impacts the final wall thickness. Any such alterations unexpectedly leads to unique physical and physiochemical properties of such microcapsules that are customized towards active ingredients of choice.

In another embodiment, one can optionally employ a dispersing agent to suspend or dissolve the substantially water-insoluble active agent. Dispersing agents contemplated for use in the practice of the present invention include any non-aqueous solvents that are capable of suspending or dissolving the active insecticide agent, but does not chemically react with either the polymer employed to produce the active agent or the active agent itself.

Examples of such solvent include vegetable oils such as, soybean oil, epoxidized soybean oil, coconut oil, olive oil, safflower oil, cotton seed oil, corn oil, rape seed oil and the like. Other such liquids include aliphatic, cycloaliphatic, or aromatic hydrocarbons such as dodecane, n-decane, n-hexane, cyclohexane, toluene, benzene, and the like; as well as, aliphatic or aromatic alcohols such as heptanol, octanol, and the like, or combinations of any two or more thereof. Other examples for suitable solvent include petroleum distillate, heavy aromatic naphthalene depleted (Aromatic 200, 100, 150) having a boiling point in the range of 100° and 400° C.

In at least one embodiment, the insecticide can be any of the following group of active ingredients:

A1) the class of carbamates, including aldicarb, alanycarb, benfuracarb, carbaryl, carbofuran, carbosulfan, methiocarb, methomyl, oxamyl, pirimicarb, propoxur and thiodicarb;

A2) the class of organophosphates, including acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon;

A3) the class of cyclodiene organochlorine compounds such as endosulfan;

A4) the class of fiproles, including ethiprole, fipronil, pyrafluprole and pyriprole;

A5) the class of neonicotinoids, including acetamiprid, clothianidin, dinotefuran, imidacloprid, nitenpyram, thiacloprid and thiamethoxam;

A6) the class of spinosyns such as spinosad and spinetoram;

A7) chloride channel activators from the class of mectins, including abamectin, emamectin benzoate, ivermectin, lepimectin and milbemectin;

A8) juvenile hormone mimics such as hydroprene, kinoprene, methoprene, fenoxycarb and pyriproxyfen;

A9) selective homopteran feeding blockers such as pymetrozine, flonicamid and pyrifluquinazon;

A10) mite growth inhibitors such as clofentezine, hexythiazox and etoxazole;

A11) inhibitors of mitochondrial ATP synthase such as diafenthiuron, fenbutatin oxide and propargite; uncouplers of oxidative phosphorylation such as chlorfenapyr;

A12) nicotinic acetylcholine receptor channel blockers such as bensultap, cartap hydrochloride, thiocyclam and thiosultap sodium;

A13) inhibitors of the chitin biosynthesis type 0 from the benzoylurea class, including bistrifluron, diflubenzuron, flufenoxuron, hexaflumuron, lufenuron, novaluron and teflubenzuron;

A14) inhibitors of the chitin biosynthesis type 1 such as buprofezin;

A15) moulting disruptors such as cyromazine;

A16) ecdyson receptor agonists such as methoxyfenozide, tebufenozide, halofenozide and chromafenozide;

A17) octopamin receptor agonists such as amitraz;

A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim;

A19) voltage-dependent sodium channel blockers such as indoxacarb and metaflumizone;

A20) inhibitors of the lipid synthesis such as spirodiclofen, spiromesifen and spirotetramat;

A21) ryanodine receptor-modulators from the class of diamides, including flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chloranthraniliprole and cy-anthraniliprole;

A22) compounds of unknown or uncertain mode of action such as azadirachtin, amidoflumet, bifenazate, fluensulfone, piperonyl butoxide, pyridalyl, sulfoxaflor; or

A23) sodium channel modulators from the class of pyrethroids, including acrinathrin, allethrin, bifenthrin, cyfluthrin, lambda-cyhalothrin, cyper-methrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

In one embodiment, the pyrethroid is selected from the group consisting of bifenthrin, zeta-cypermethrin, alpha-cypermethrin, permethrin, lambda-cyhalothrin, and tefluthrin. In at least one embodiment pyrethroid may are present in amounts ranging from 25% to 60% w/w. In one embodiment, the bifenthrin amount is between 35 and 50% w/w.

In another embodiment, the formulation of the present invention may further contain an antifoam agent, and a pore making agent.

The formulations of the present invention may also include dispersants, viscosity modifier, pH modifiers and/or preservatives, the selection of which is known to those skilled in the arts of formulating dispersions, suspoemulsions and other similar products.

Suitable dispersants include nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulfates, alkyl- or arylsulfonates and alkyl or aryl phosphates or the corresponding PO-ether adducts, and mixtures thereof. Alkyl polyglucosides and phosphate esters are preferred dispersants.

Suitable preservatives include but are not limited to C12 to C15 alkyl benzoates, alkyl p-hydroxybenzoates, aloe vera extract, ascorbic acid, benzalkonium chloride, benzoic acid, benzoic acid esters of C9 to C15 alcohols, butylated hydroxytoluene, butylated hydroxyanisole, tert-butylhydroquinone, castor oil, cetyl alcohols, chlorocresol, citric acid, cocoa butter, coconut oil, diazolidinyl urea, diisopropyl adipate, dimethyl polysiloxane, DMDM hydantoin, ethanol, ethylenediaminetetraacetic acid, fatty acids, fatty alcohols, hexadecyl alcohol, hydroxybenzoate esters, iodopropynyl butylcarbamate, isononyl iso-nonanoate, jojoba oil, lanolin oil, mineral oil, oleic acid, olive oil, parabens, polyethers, polyoxypropylene butyl ether, polyoxypropylene cetyl ether, potassium sorbate, propyl gallate, silicone oils, sodium propionate, sodium benzoate, sodium bisulfite, sorbic acid, stearic fatty acid, sulfur dioxide, and derivatives, esters, salts and mixtures thereof. Preferred preservatives include sodium o-phenylphenate, 5-chloro-2-methyl-4-isothiazolin-3-one, 2-methyl-4-isothiazolin-3-one, KATHON®, and 1,2-benzisothiazolin-3-one.

Suitable viscosity modifying agents include but are not limited to glycerine, KELZAN®, carrageenan, xanthan gum, guar gum, gum Arabic, gum tragacanth, polyox, alginin, attapulgite clays, smectite clays and sodium alginate. Xanthan gum is particularly preferred. The total concentration of viscosity enhancing agents in the formulation may comprise between 0.01% and 15% of the total formulation, more preferably 0.1-5% (w/w).

Suitable pH modifiers include acetic acid, hydrochloric acid, citric acid, phosphoric acid, buffers and the like.

In a more preferred embodiment, the microcapsules are a core-shell structure containing a pyrethroid such as bifenthrin, and a suitable combination of solvent and crop oil. In such embodiment, the shell wall of microcapsules is polyuria, which is formed via emulsion polymerization process and cross-linked with acetic acid ethenyl ester. The cross-linking agent is acetic acid ethenyl ester (polyvinyl alcohol and polyvinyl acetate). At least another aspect of such an embodiment is providing reduced oral toxicity while improving the handler's safety.

Various methods of preparing polymeric microcapsule are described in the art. Such methods include solvent extraction, hot melt encapsulation, solvent evaporation and spray drying. In a preferred embodiment, the microcapsules of the present invention are prepared following the general steps of (1) making organic mixture phase by mixing agrochemicals with selected solvents/oils, (2) making an emulsion by using selected surfactants, monomers, and other additives, (3) adding the monomers to activate interfacial polymerization, (4) and allowing interfacial polymerization for sufficient amount of time, preferably between 5-24 hours at preset temperature and pH 2-5. In another aspect of the invention, interfacial polymerization occurs at a temperature ranging from 25 to 65° C. In a more preferred embodiment, the interfacial polymerization occurs at a temperature ranging from 45 to 60° C.

In at least another embodiment, bifenthrin loading can be made from 5% and up to about 48%. In a preferred embodiment, bifenthrin can be present in amounts of about 10%, 20%, 30%, 40%, 50% or 60% in the final product. In another aspect of the invention, the targeted amount of bifenthrin loading ranges from about 300 to about 600 grams of the active ingredient per liter.

In at least one exemplary embodiment, an organic mixture is prepared by mixing melt bifenthrin technical with pre-determined amount of corn oil, Aromatic 200 ND solvent and PAPI® 27, keep the mixture in oven (65° C.) before homogenization. In similar manner the aqueous mixture is prepared by dissolving pre-determined amounts of REAX® 88B, SELVOL® 24-203 and KELZAN® S in deionized water, keeping the mixture in the oven (at 65° C.). Subsequently, an Amine Solution is prepared by mixing a pre-determined amount of, for example, 1,6-hexanediamine with deionized water. The product may next be homogenized with Polytron PT6100 homogenizer and PT-DA3030-6060 dispersing aggregates: slowly charge organic mixture (Phase I) into aqueous mixture (Phase II), homogenize at 19K rpm for 2 minutes. In the next step, the capsule slurry is jacked into a jacked reactor (temperature set at 52° C.). The mixture is then start stirring at 200 rpm, and slowly (drop by drop) add amine solution (Phase III) into the slurry in the reactor. The stirring of the mixture should continue for 5 hours at the 52° C., then set the water bath temperature to RT and continue stirring for 3 hours. The pH is subsequently adjusted to neutral with 85% phosphoric acid or acetic acid. Other ingredients such as proxel GXL and Kelzan S (2%)/water to are then added to adjust viscosity and active loading to the desired level. In one embodiment the ratios of Bifenthrin:Corn oil:Aromatic 200ND are respectively 81.5%:13.5%:4%, while in another embodiment the same is in the range of 87%:7.6%:5.4%.

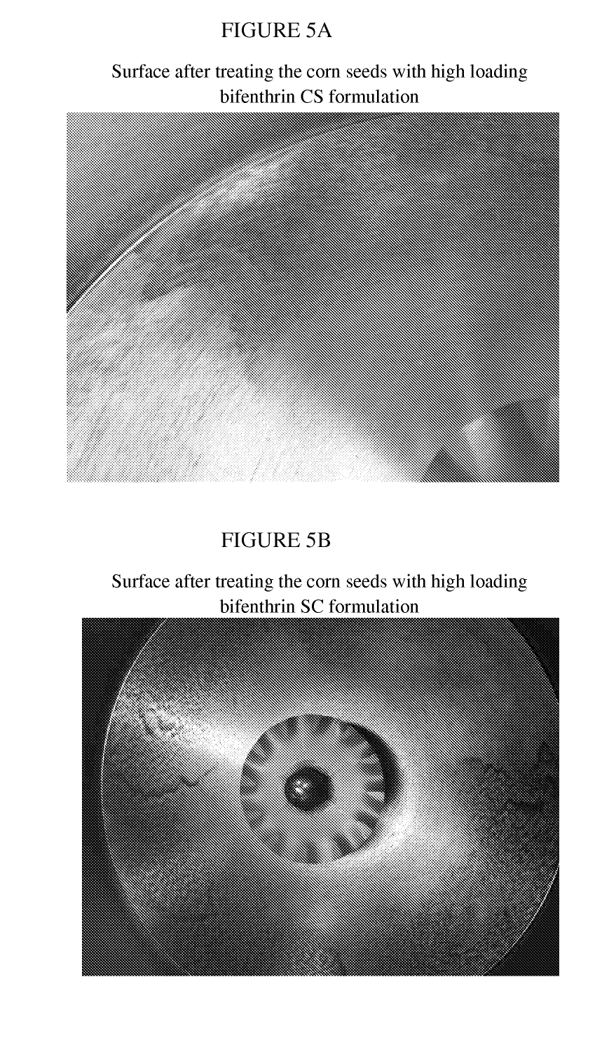

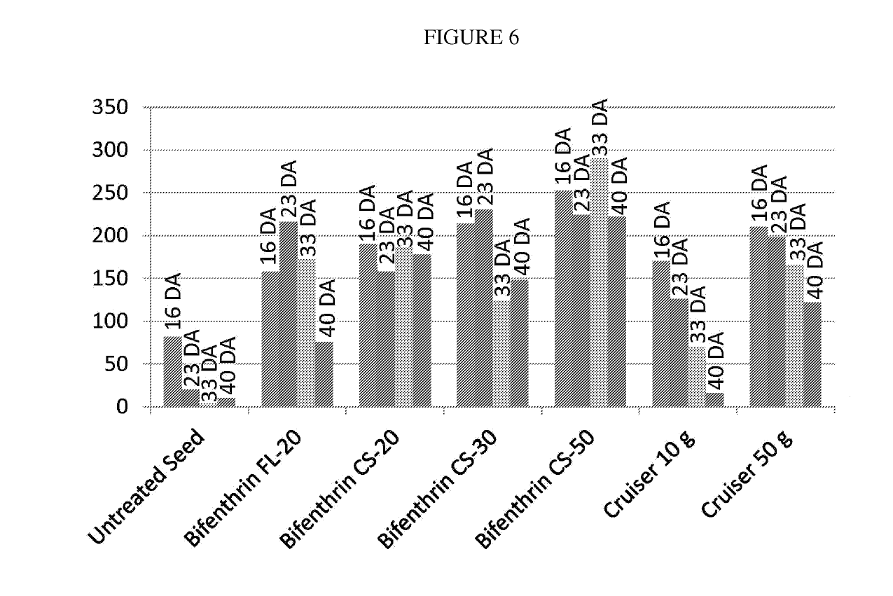

In another embodiment, the present invention provides methods of treating seeds to protect them from insects and possibly other pests. At least one advantage of the present invention can be realized on its operational impacts and equipment. Those of ordinary skill in the art can appreciate that bifenthrin and other insecticides damage equipment by causing ingredient build up on such equipment. This shortcoming hampers operational efficiency. Those of ordinary skill in the art can appreciate that encapsulating bifenthrin, as opposed to applying as a conventional suspension concentrate, reduces the amount of build-up on the treating equipment (see FIGS. 5 (A)-(B)). To that extent, such advantage affords significant operational efficiency.

In another embodiment, the present invention may be used to protect such crops as wheat, corn, barley, beans, cereals, citrus, cocoas, coconuts, coffee, corn, cotton, fiber crops, flowers, forge corps, forestry, groundnuts, peanuts, hops, horticultures, non-land crops, oil palm, oilseed rape, peas, pomes, potato, rice, stonefruit, spices, sugar cane Sunflower, tea, tobacco, tomatoes, tree nuts, turf, vegetable crops, vines, and grapes and the like.

In at least another embodiment, the present invention provides superior toxicity results as compared to comparable conventional suspensions. As such, the claimed microencapsulation process reduces toxicity of the formulation thereby improving the safety profile not only for the consumer but also in the local environment.

In at least another embodiment, the present invention allows delivery of products with higher active ingredient contents as compared to other polymer encapsulated insecticide containing products. Those of ordinary skill in the art can appreciate that such features provides added advantages in seed treatment operations and significantly reduces packaging requirements.

In at least another aspect of the invention, coated seed are provided that comprise a seed and a coating and wherein the coating is a plurality of microcapsules wherein each microcapsule comprises an outer polymeric shell encapsulating a core comprising an active ingredient. In a preferred embodiment such active ingredient is a pyrethroid bifenthrin. In a more preferred embodiment, the coated seed of the present invention is coated with microcapuses having outer polymeric shell comprising at least one polymer selected from the group consisting of polyureas, polyurethanes, polyamides, and polyesters.

In another embodiment, the coated seed of the present invention has an outer shell made of polyurea. In yet another embodiment, the coated seed of the present invention is coated with microcapsules having active ingredient, a solvent and/or an oil in its core. In another embodiment, the solvent is an organic solvent selected from the group consisting of petroleum (Aromatic 200 ND), or other hydrophobic solvents and the coating formulation further contains (a) a co-solvent; (b) effective amounts of isocyanate; (c) a dispersant; (d) polyvinyl alcohol; (e) viscosity modifying agents (f) antifoam agent (such as a silicone emulsion mixture); (g) a biocide (such as 1,3-benzisothiazol-3-one); (h) an amine; and (i) a pH modifier.

The compositions and methods of the present invention are further illustrated by the following examples. These examples serve merely to illustrate particular embodiments of the invention and are not intended to limit the scope of the invention in any way. Further modifications encompassed by the disclosed invention will be apparent to those skilled in the art. All such modifications are deemed to be within the scope of the invention as defined in the present specification and claims.

### EXAMPLES

### Example 1. Methods of Making High Loading Bifenthrin Microencapsulated Formulations

Table 1 sets forth the constitution of the instantly described high loading microcapsules formulations. The process of making high loading microcapsules follow the general steps of (1) making organic mixture phase by mixing agrochemicals with selected solvents/oils, (2) making an emulsion by using selected surfactants, monomers, and other additives, (3) adding the monomers to activate interfacial polymerization, (4) and allowing interfacial polymerization for 2-24 hours at preset temperature and pH.

### Step A—Preparing the Organic Phase

35-48% w/w of bifenthrin technical was mixed with 6.4% of corn oil, 2.7% Aromatic 200 ND solvent (Petroleum, heavy aromatic, naphthalene depleted) and 2.0% of polymethylene polyphenyl isocyanate containing 4, 4′ Methylene bisphenyl isocyanate. The mixture was then kept in oven at a temperature of 65° C. before homogenization. All weight measurements are in percent by weight (% w/w).

### Step B—Preparing the Aqueous Mixture

1.1% w/w of highly sulfonated Kraft lignin (REAX® 88B) was blended with at high speed, 0.8% of SELVOL® 24-203 and 0.05% of KELZAN® S are dissolved in deionized (D.I.) water and kept in the oven at temperature of 65° C.

### Step C—Homogenization of the Mixture

The aqueous mixture and the organic mixture were slowly mixed with a Polytron PT6100 homogenizer and PT-DA3030-6060 dispersing aggregates at 19K rpm for 2 minutes.

### Step D—Post Homogenization Treatment

The mixture was then transferred into jacked reactor at temperature set at 52° C. and stirred at 200 rpm. An amine mixture of about 70% 1,6 hexanediamine with DI water was added to the stirring mixture slowly. The mixture was stirred continuously at the 52° C. for at least 2 hours. The pH of the mixture was then adjusted to neutral (about pH=7) with 85% phosphoric acid or acetic acid. Xanthan Gum (2% solution in water containing 0.5% 1,3-benzisothiazol-3-one biocide) was then added in water to adjust viscosity and active loading to the desired level.

TABLE 1
Example of high loading bifenthrin microencapsulated formulation

| Ingredients | Chemical Name | Percentage |
|---|---|---|
| Bifenthrin | (2-methyl[1,1′-biphenyl]-3- | 39.67% |
| | yl)methyl 3-(2-chloro-3,3,3- | |
| | trifluoro-1-propenyl)-2,2- | |
| | dimethylcyclopropanecarboxylate | |
| Corn oil | Vegetable oil | 6.4% |
| Aromatic 200ND | Solvent (petroleum), heavy | 2.7% |
| | aromatic naphtha depleted | |
| Polymeric isocyanate | Polymethylene polyphenyl | 2.0% |
| (PAPI ® 27) | isocyanate containing 4,4′ | |
| | Methylene bisphenyl isocyanate | |
| REAX ® 88B | Lignosulfonic acid, sodium salt, | 1.1% |
| | sulfomethylated | |
| SELVOL ® 24-203 | Acetic acid ethenyl ester, | 0.8% |
| | polymer with ethenol, 24% | |
| KELZAN ® S | Xanthan Gum | 0.05% |
| Dow Corning | Silicone emulsion, mixture | 0.05% |
| Antifoam 1520 | | |
| PROXEL ® GXL | 1,3-benzisothiazol-3-one, mixture | 0.03% |
| Hexamethylenediamine | 1,6-hexanediamine, 70% | 1.8% |
| Phosphoric acid | Phosphoric acid, 85% | 0.8% |
| Water | Balance to q.s. 100% | (44.6%) |
| Total | | 100% |

Additional formulations were prepared in the same manner as Example 1 Steps A-D and are summarized in Tables 2 and 3 below. Tables 2 and 3 summarize various chemical and physical properties associated with these formulations.

TABLE 2
Physical and chemical properties of high loading
bifenthrin microencapsulated formulation:

| Batch # | | G-145 | G-147 | G-001 | G-003 |
|---|---|---|---|---|---|
| pH Adjusted | | 50%/ | 100% | 85% | 85% |
| with | | 100% | | | |
| | | acetic | acetic | Phos- | Phos- |
| | | acid | acid | phoric | phoric |
| | | | | acid | acid |
| % Monomer | | 2% | 2% | 2% | 3% |
| pH | | 7.5 | 7.8 | 7.7 | 7.1 |
| Solvent/Oil | | | No | | Reduced |
| in Core | | | | | |
| Shell Wall | | | Thin | | Middle |
| Thickness | | | 1x | | 1.5x |
| AI Assays | % w/w | 40.3% | 39.8% | 40.2% | 40.2% |
| (final) | | | | | |
| Density | g/cm³ | 1.0906 | 1.0992 | 1.0975 | 1.1037 |
| Loading, A.I. | g/L | 440 | 437 | 441.2 | 444 |
| Particle Size | D90 | 3.4 | 4.9 | 3.9 | 3.9 |
| (Formulation) | D50 | 2.0 | 2.5 | 2.1 | 2.3 |
| Viscosity | @5 rpm | 1080-1120 | 1320 | 3080 | 2560-2640 |
| Batch # | | G-132 | G-127 | G-320 | G-284 |
| Solvent/Oil | | Yes | Yes | Reduced | Reduced |
| in Core | | | | | |
| Shell Wall | | Thin | Thick | Thin | Thin |
| Thickness | | 1x | 2x | 1x | 1x |
| pH | | 6.07 | 6.51 | 7.69 | 7.10 |
| AI Assays | % w/w | 40.0% | 35.7% | 37.4% | 37.2% |
| (final) | | | | | |
| Density | g/cm³ | 1.0787 | 1.0851 | 1.0878 | 1.0856 |
| Loading, A.I. | g/L | 431 | 387 | 407 | 404 |
| Particle Size | D90 | 2.6 | 4.6 | 15 | 15 |
| (Formulation) | D50 | 1.6 | 2.3 | 8.2 | 8.0 |

### Table 3.

### Assessment of the Toxicity Profile

As shown in Table 4 below, the quick toxicity study indicates that microencapsulating bifenthrin has reduced the oral LD₅₀ toxicity of the high loading bifenthrin formulation, subsequently providing significant improvement for consumers and intermediary handlers.

TABLE 4
Result of the toxicity study

| | Bifenthrin SC | Bifenthrin CS |
|---|---|---|
| | (Suspension Concentrate) | (Microcapsule Suspension) |
| eye irritation | Mild irritation. | Mild irritation. |
| | EPA Category III | EPA Category III |
| | CAUTION | CAUTION |
| skin irritation | Mild irritation. | No irritation |
| | EPA Category IV | EPA Category IV |
| | CAUTION | CAUTION |
| Dermal LD₅₀ | >2000 mg/kg, with | >2000 mg/kg. |
| | significant pharmocotoxic | EPA Cat III |
| | signs. 1 out of 3 animals | (CAUTION) |
| | died. EPA Category III | |
| | (CAUTION) | |
| Oral LD₅₀ | <500 mg/kg. | >500 mg/kg. |
| | 2 out of 3 animals died | EPA Cat III |
| | EPA Category I or II | |

### Example 2: Impact of Bifenthrin Seed Treatment on Grubs and Wireworm Damage on Spring Wheat

Initially seed treatment composition was prepared by diluting a fungicide, as the control treatment, in water and slurried to 325 mL per 100 kg and applied simultaneously with the insecticide, also diluted to 325 mL/100 kg slurry. The exception was CRUISER® which was tank mixed with the fungicides and diluted with water to a final slurry rate of 325 mL/100 kg. Seeds were treated in the Hege treater. Encapsulated Bifenthrin at 400 g/L and encapsulated Carbosulfan at 550 g/L were then compared for efficacy of seed treatment against non-encapsulated and other commercially comparable products. The rate and formulations tested are provided herein below in Table 5.

TABLE 5
Test Treatments

| Trt | | Form | Form | Form | | |
|---|---|---|---|---|---|---|
| No. | Treatment Name | Conc | Unit | Type | Rate | Rate Unit |
| 1 | DIVIDEND EXTREME | 115 | G/L | FS | 130 | ml/100 kg |
| | TEBUSTAR 250 ST | 300 | G/L | FS | 3 | ml/100 kg |
| | TOPSIN 4.5FL | 540 | G/L | SC | 18.2 | ml/100 kg |
| 2 | FUNGICIDE CONTRO | | | | 141.2 | ml/100 kg |
| | Bifenthrin FL | | | | 50 | ml/100 kg |
| 3 | FUNGICIDE CONTRO | | | | 141.2 | ml/100 kg |
| | Encapsulated Bifenthrin | | | | 50 | ml/100 kg |
| 4 | FUNGICIDE CONTRO | | | | 141.2 | ml/100 kg |
| | Encapsulated Bifenthrin | | | | 75 | ml/100 kg |
| 5 | FUNGICIDE CONTRO | | | | 141.2 | ml/100 kg |
| | Encapsulated Bifenthrin | | | | 120 | ml/100 kg |
| 6 | FUNGICIDE CONTRO | 600 | G/L | FS | 141.2 | ml/100 kg |
| | CRUISER | | | | 83 | ml/100 kg |
| 7 | FUNGICIDE CONTRO | 600 | G/L | FS | 141.2 | ml/100 kg |
| | CRUISER | | | | 17 | ml/100 kg |
| 8 | FUNGICIDE CONTRO | 600 | G/L | FS | 141.2 | ml/100 kg |
| | CRUISER | | | | 17 | ml/100 kg |
| | Bifenthrin FL | | | | 50 | ml/100 kg |
| 9 | FUNGICIDE CONTRO | 600 | G/L | FS | 141.2 | ml/100 kg |
| | CRUISER | | | | 17 | ml/100 kg |
| | Bifenthrin FL | | | | 50 | ml/100 kg |
| 10 | FUNGICIDE CONTRO | | | | 141.2 | ml/100 kg |
| | Encapsulated | | | | 18 | ml/100 kg |
| | Carbosulfan | | | | | |
| 11 | FUNGICIDE CONTRO | | | | 141.2 | ml/100 kg |
| | Encapsulated | | | | 45 | ml/100 kg |
| | Carbosulfan | | | | | |
| 12 | FUNGICIDE CONTRO | | | | 141.2 | ml/100 kg |
| | Encapsulated | | | | 90 | ml/100 kg |
| | Carbosulfan | | | | | |

The encapsulated and unencapsulated treated seeds were compared against each other in a 0.011 acers plot of Milford Silt Clay Loam soil type in a field experiment. The encapsulated and unencapsulated treated seeds were also compared against untreated seeds in the same environment. During the field experiment 24 seeds per foot of row (approximately 110 pounds seed per acre) were planted at a depth of 1 inch. The tested crops was Triticum aestivum (Spring Wheat).

The efficacy of the respective test products were then measured against western wireworm and white grub at application rates of 50, 75, and 120 of bifenthrin and at rates of 18, 45 and 90 of carbosulfan. Assessment of all insecticide seed treatments was observed to be significantly better compared to the fungicide control treatment. The following Tables 6, 7 and 8 provide details related to specific field results:

TABLE 6
Crop count and phytotoxicity measurements for each treatment.

| | | | | Pest Type | | | | |
|---|---|---|---|---|---|---|---|---|
| | | | | Insect | Insect | Insect | Insect | Insect |
| | | | | Pest Scientific Name | | | | |
| | | | | Agriotes spars | Agriotes spars | Agriotes spars | Agriotes spars | Agriotes spars |
| | | | | Pest Name | | | | |
| | | | | Western wirewo | Western wirewo | Western wirewo | Western wirewo | Western wirewo |
| | | | | Crop Scientific Name | | | | |
| | | | | Triticum aesti | Triticum aesti | Triticum aesti | Triticum aesti | Triticum aesti |
| | | | | Crop Name | | | | |
| | | | | Spring wheat | Spring wheat | Spring wheat | Spring wheat | Spring wheat |
| | | | | Observation type: | | | | |
| | | | | Crop Count | Crop Count | Crop Count | Crop Count | Phytotoxicity |
| | | | | Appl Code | | | | |
| Trt No. | Treatment Name | Rate | Rate Unit | 1 | 2 | 3 | 4 | 5 |
| 1 | DIVIDEND EXTREME | 130 | ml/100 kg | 57.4 | 1219680 | 2988216 | 72.9 | 0.0 |
| | TEBUSTAR 250 ST | 3 | ml/100 kg | | | | | |
| 2 | CONTROL | 141.2 | ml/100 kg | 67.3 | 1428768 | 3500482 | 85.4 | 0.0 |
| | Bifenthrin FL | 50 | ml/100 kg | | | | | |
| 3 | CONTROL | 141.2 | ml/100 kg | 72.2 | 1533312 | 3756615 | 91.7 | 0.0 |
| | ENCAPS Bifenthrin | 50 | ml/100 kg | | | | | |
| 4 | CONTROL | 141.2 | ml/100 kg | 73.8 | 1568160 | 3841992 | 93.8 | 0.0 |
| | ENCAPS Bifenthrin | 75 | ml/100 kg | | | | | |
| 5 | CONTROL | 141.2 | ml/100 kg | 73.8 | 1568160 | 3841992 | 93.8 | 0.0 |
| | ENCAPS Bifenthrin | 120 | ml/100 kg | | | | | |
| 6 | CONTROL | 141.2 | ml/100 kg | 69.7 | 1481040 | 3628548 | 88.6 | 0.0 |
| | CRUISER | 17 | ml/100 kg | | | | | |
| 7 | CONTROL | 141.2 | ml/100 kg | 73.8 | 1568160 | 3841992 | 93.8 | 0.0 |
| | CRUISER | 83 | ml/100 kg | | | | | |
| 8 | CONTROL | 141.2 | ml/100 kg | 76.3 | 1620432 | 3970059 | 96.9 | 0.0 |
| | CRUISER | 17 | ml/100 kg | | | | | |
| | Bifenthrin FL | 50 | ml/100 kg | | | | | |
| 9 | CONTROL | 141.2 | ml/100 kg | 74.6 | 1585584 | 3884681 | 94.8 | 0.0 |
| | CRUISER | 17 | ml/100 kg | | | | | |
| | ENCAPS Bifenthrin | 50 | ml/100 kg | | | | | |
| 10 | CONTROL | 141.2 | ml/100 kg | 73.8 | 1568160 | 3841992 | 93.8 | 0.0 |
| | ENCAPS Carbosulfan | 18 | ml/100 kg | | | | | |
| 11 | CONTROL | 141.2 | ml/100 kg | 75.5 | 1603008 | 3927370 | 95.9 | 0.0 |
| | ENCAPS Carbosulfan | 45 | ml/100 kg | | | | | |
| 12 | CONTROL | 141.2 | ml/100 kg | 75.5 | 1603008 | 3927370 | 95.8 | 0.0 |
| | ENCAPS Carbosulfan | 90 | ml/100 kg | | | | | |

| | | | | | |
|---|---|---|---|---|---|
| LSD (P = .10) | 4.06 | 86564.1 | 212082.4 | 5.17 | 0.00 |
| Standard Deviation | 3.39 | 72139.2 | 176741.2 | 4.31 | 0.00 |
| CV | 4.71 | 4.72 | 4.72 | 4.72 | 0.0 |

TABLE 7
Vigor and crop stand measurements.

| | | | | Pest Type | | | | |
|---|---|---|---|---|---|---|---|---|
| | | | | Insect | Insect | Insect | Insect | Insect |
| | | | | Pest Scientific Name | | | | |
| | | | | Agriotes spars | Agriotes spars | Agriotes spars | Agriotes spars | Agriotes spars |
| | | | | Pest Name | | | | |
| | | | | Western wirewo | Western wirewo | Western wirewo | Western wirewo | Western wirewo |
| | | | | Crop Scientific Name | | | | |
| | | | | Triticum aest | Triticum aest | Triticum aest | Triticum aest | Triticum aest |
| | | | | Crop Name | | | | |
| | | | | Spring wheat | Spring wheat | Spring wheat | Spring wheat | Spring wheat |
| | | | | Observation type: | | | | |
| | | | | Vigor | Cropstand | Cropstand | Cropstand | Cropstand |
| | | | | Appl Code | | | | |
| Trt No. | Treatment Name | Rate | Rate Unit | 6 | 7 | 8 | 9 | 10 |
| 1 | DIVIDEND EXTREME | 130 | ml/100 kg | 6.0 | 56.6 | 1202256 | 2945528 | 71.9 |
| | TEBUSTAR 250 ST | 3 | ml/100 kg | | | | | |
| 2 | CONTROL | 141.2 | ml/100 kg | 8.0 | 61.5 | 1306800 | 3201660 | 78.1 |
| | Bifenthrin FL | 50 | ml/100 kg | | | | | |
| 3 | CONTROL | 141.2 | ml/100 kg | 8.5 | 73.0 | 1550736 | 3799304 | 92.7 |
| | ENCAPS Bifenthrin | 50 | ml/100 kg | | | | | |
| 4 | CONTROL | 141.2 | ml/100 kg | 9.0 | 75.5 | 1603008 | 3927370 | 95.9 |
| | ENCAPS Bifenthrin | 75 | ml/100 kg | | | | | |
| 5 | CONTROL | 141.2 | ml/100 kg | 9.0 | 74.7 | 1585584 | 3884681 | 94.8 |
| | ENCAPS Bifenthrin | 120 | ml/100 kg | | | | | |
| 6 | CONTROL | 141.2 | ml/100 kg | 8.5 | 68.1 | 1446192 | 3543171 | 86.5 |
| | CRUISER | 17 | ml/100 kg | | | | | |
| 7 | CONTROL | 141.2 | ml/100 kg | 8.5 | 68.9 | 1463616 | 3585859 | 87.5 |
| | CRUISER | 83 | ml/100 kg | | | | | |
| 8 | CONTROL | 141.2 | ml/100 kg | 9.0 | 73.0 | 1550736 | 3799304 | 92.7 |
| | CRUISER | 17 | ml/100 kg | | | | | |
| | Bifenthrin FL | 50 | ml/100 kg | | | | | |
| 9 | CONTROL | 141.2 | ml/100 kg | 9.5 | 75.5 | 1603008 | 3927370 | 95.8 |
| | CRUISER | 17 | ml/100 kg | | | | | |
| | ENCAPS Bifenthrin | 50 | ml/100 kg | | | | | |
| 10 | CONTROL | 141.2 | ml/100 kg | 8.5 | 70.6 | 1498464 | 3671237 | 89.6 |
| | ENCAPS Carbosulfan | 18 | ml/100 kg | | | | | |
| 11 | CONTROL | 141.2 | ml/100 kg | 9.0 | 70.6 | 1498464 | 3671237 | 89.6 |
| | ENCAPS Carbosulfan | 45 | ml/100 kg | | | | | |
| 12 | CONTROL | 141.2 | ml/100 kg | 9.0 | 73.8 | 1568160 | 3841992 | 93.8 |
| | ENCAPS Carbosulfan | 90 | ml/100 kg | | | | | |

| | | | | | |
|---|---|---|---|---|---|
| LSD (P = .10) | 1.18 | 5.18 | 109994.9 | 269487.6 | 6.58 |
| Standard Deviation | 0.99 | 4.32 | 91665.4 | 224580.4 | 5.48 |
| CV | 11.54 | 6.15 | 6.15 | 6.15 | 6.15 |

TABLE 8
Crop yield, density and insect damage measurements.

| | | | | Pest scientific name | | | | |
|---|---|---|---|---|---|---|---|---|
| | | | | | | | Agriotes spars | Trochalus poli |
| | | | | Pest name | | | | |
| | | | | | | | Western wirewo | White grub |
| | | | | Crop Scientific Name | | | | |
| | | | | Triticum aest | Triticum aest | Triticum aest | Triticum aest | Triticum aest |
| | | | | Crop Name | | | | |
| | | | | Spring wheat | Spring wheat | Spring wheat | Spring wheat | Spring wheat |
| | | | | Observation type: | | | | |
| | | | | Yield bushel/acer | Yield kg/ha | Density | Insect Damage % | Insect Damage % |
| | | | | Appl Code | | | | |
| Trt No. | Treatment Name | Rate | Rate Unit | 11 | 12 | 13 | 14 | 15 |
| 1 | DIVIDEND EXTREME | 130 | ml/100 kg | 31.1 | 2056 | 57.2 | 18.3 | 3.3 |
| | TEBUSTAR 250 ST | 3 | ml/100 kg | | | | | |
| 2 | CONTROL | 141.2 | ml/100 kg | 33.6 | 2223 | 54.7 | 14.8 | 2.3 |
| | Bifenthrin FL | 50 | ml/100 kg | | | | | |
| 3 | CONTROL | 141.2 | ml/100 kg | 37.8 | 2504 | 58.1 | 8.8 | 1.3 |
| | ENCAPS Bifenthrin | 50 | ml/100 kg | | | | | |
| 4 | CONTROL | 141.2 | ml/100 kg | 40.4 | 2677 | 58.3 | 7.8 | 1.0 |
| | ENCAPS Bifenthrin | 75 | ml/100 kg | | | | | |
| 5 | CONTROL | 141.2 | ml/100 kg | 41.7 | 2762 | 58.4 | 4.8 | 0.8 |
| | ENCAPS Bifenthrin | 120 | ml/100 kg | | | | | |
| 6 | CONTROL | 141.2 | ml/100 kg | 34.8 | 2193 | 58.0 | 12 | 1.8 |
| | CRUISER | 17 | ml/100 kg | | | | | |
| 7 | CONTROL | 141.2 | ml/100 kg | 33.1 | 2193 | 58.1 | 10.3 | 2.3 |
| | CRUISER | 83 | ml/100 kg | | | | | |
| 8 | CONTROL | 141.2 | ml/100 kg | 39.1 | 2587 | 58.3 | 7.0 | 0.8 |
| | CRUISER | 17 | ml/100 kg | | | | | |
| | Bifenthrin FL | 50 | ml/100 kg | | | | | |
| 9 | CONTROL | 141.2 | ml/100 kg | 40.0 | 2652 | 58.4 | 7.0 | 1.0 |
| | CRUISER | 17 | ml/100 kg | | | | | |
| | ENCAPS Bifenthrin | 50 | ml/100 kg | | | | | |
| 10 | CONTROL | 141.2 | ml/100 kg | 36.5 | 2416 | 57.9 | 7.5 | 1.5 |
| | ENCAPS Carbosulfan | 18 | ml/100 kg | | | | | |
| 11 | CONTROL | 141.2 | ml/100 kg | 40.4 | 2672 | 58.0 | 10.0 | 1.5 |
| | ENCAPS Carbosulfan | 45 | ml/100 kg | | | | | |
| 12 | CONTROL | 141.2 | ml/100 kg | 40.7 | 2694 | 58.0 | 6.0 | 0.8 |
| | ENCAPS Carbosulfan | 90 | ml/100 kg | | | | | |

| | | | | | |
|---|---|---|---|---|---|
| LSD (P = .10) | 2.22 | 147.2 | 0.23 | 3.4 | 1.46 |
| Standard Deviation | 1.85 | 122.7 | 1.22 | 2.83 | 1.22 |
| CV | 4.95 | 4.95 | 81.24 | 28.79 | 81.24 |

The first count is presented with four different units with all being converted from a single count. All insecticide seed treatments were significantly improved compared to the fungicide. Emergence was noticeably reduced by wireworm feeding.

The second count is presented with four different units with all being converted from a singled count. All insecticide seed treatments were significantly improved compared to the fungicide control with the exception of Bifenthrin Flowable. Treatments 2 and 3 contain identical loading of Bifenthrin applied to the seed. The observed difference could be due to advantage of the encapsulation or the flowable having poor coverage on the seed due to poor formulation properties. Emergence was again noticeably reduced by wireworm feeding.

Vigor was then determined at the first assessment timing. All insecticide seed treatments were improved over the fungicide control. At the second timing, Vigor was improved by all insecticide seed treatments with the exception of Treatment 2 (Flowable Bifenthrin) and Treatment 6 (thiamethoxam low rate 10 g ai/100 kg) at the second assessment timing.

Treatment 2 and Treatment 10 had lower damage due to wireworm feeding than the fungicide but also provided a lower level of protection than other treatments. The lowest damage was in the highest rate of encapsulated Bifenthrin (50 g ai/100 kg).

Review of the results provided that the Treatment 2 and Treatment 10 had lower damage than the fungicide but provided a lower level of protection than other treatments. The lowest damage was observed at the highest rate of encapsulated Bifenthrin (50 g ai/100 kg).

The results further highlighted that damage due to feeding grubs were generally low, however, with the greatest numerical reduction caused by bifenthrin at its highest rate, carbosulfan highest rate and thiamethoxam plus Bifenthrin.

All the insecticide seed treatments with the exception of the low rate of Bifenthrin flowable formulation (Treatment 2) increased bushel weight. Less vigorous plants due to feeding damage may result in plant seed being lighter (lower weight).

All insecticide seed treatments with the exception of Treatment 2 resulted in significantly higher yield than the fungicide check. Bifenthrin at 50 g ai/100 kg provided superior yield compared to Treatments 2, 3, 6, 7 and 10. This rate of Bifenthrin provided superior yield compared to thiamethoxam applied at the same active loading. The lowest rate of Carbosulfan was lower in yield compared to higher rates. This study supports the benefit of the higher rate of 50 g ai/100 kg of Bifenthrin providing superior protection relative to 30 g ai/100 kg. Finally, there were no phytotoxicity symptoms observed during any of treatments.

Pursuant to the results of this experiment, unique encapsulated Bifenthrin formulation of the present invention provides protection equal or superior to thiamethoxam. In contrast, the flowable form of Bifenthrin provides a lower protection as compared to the encapsulated formulation for the reason that is unknown. At least one advantage of the encapsulated formulation is in that it provides much less build up on the treater as compared to the flowable formulation which show more build-up on the treater. This observation would support a conclusion that a lower target rate was achieved on the seed than with the micro-encapsulated formulation. Regardless, those of ordinary skill in the art would appreciate the fact that the encapsulated formulation of the present invention resulted in superior efficacy.

Those of ordinary skill in the art can make modifications of the inventions described in this specification. All such changes and modifications which are within the spirit of the present invention are intended to be included in the claims.

What is claimed:

1. An insecticide composition comprising plurality of microcapsules wherein each microcapsule comprises an outer polymeric shell encapsulating a core comprising an insecticide.

2. The composition of claim 1, wherein said microcapsules are multilayer or unilayer microcapsules.

3. The composition of claim 1, wherein the outer polymeric shell comprises at least one polymer selected from the group consisting of polyureas, polyurethanes, polyamides, and polyesters.

4. The composition of claim 3, wherein the polymer of the outer polymeric shell is polyurea.

5. The composition of claim 1, wherein the core further comprises active ingredient, a solvent and/or an oil.

6. The composition of claim 5, wherein the solvent is an organic solvent selected from the group consisting of petroleum (Aromatic 200 ND), or other hydrophobic solvents.

7. The composition of claim 6, wherein the solvent is petroleum distillate, heavy aromatic (Aromatic 200, 100, 150) having a boiling point in the range of 100° and 400° C.

8. The composition of claim 5, wherein the oil is selected from the group consisting of corn oil, crop oils, soybean oil, corn oil, epoxidized soybean oil, canola oil or mixtures thereof.

9. The composition of claim 8, wherein the oil is corn oil.

10. The composition of claim 5, further comprising (a) a co-solvent; (b) effective amounts of isocyanate; (c) a dispersant; (d) polyvinyl alcohol; (e) viscosity modifying agents (f) antifoam agent (such as a silicone emulsion mixture); (g) a biocide (such as 1,3-benzisothiazol-3-one); (h) an amine; and (i) a pH modifier.

11. The composition of claim 10, wherein said co-solvent is selected from the group consisting of Aromatic 100, 150, and 200.

12. The composition of claim 11, wherein said co-solvent is Aromatic 200.

13. The composition of claim 10, wherein said viscosity modifier/enhancer is selected from the group consisting of xanthan gum, glycerine, Kelzan, carrageenan, xanthan gum, guar gum, gum Arabic, gum tragacanth, polyox, alginin, attapulgite clays, smectite clays and sodium alginate.

14. The composition of claim 13, wherein said viscosity modifier is xanthan gum.

15. The composition of claim 10, wherein said dispersant is lignosulfonate salt.

16. The composition of claim 15, wherein said salt is lignosulfonic acid-sodium salt, sulfomethylated.

17. The composition of claim 10, wherein said polyvinyl alcohol is present in an amount ranging from about 0.05% to about 2% w/w.

18. The composition of claim 10, wherein said amine is hexamethylenediamine.

19. The composition of claim 10, wherein said pH modifier is an acid selected from the group consisting of phosphoric acid, acetic acid, hydrogen chloride, and citric acid.

20. The composition of claim 2, wherein the microcapsules have a diameter size ranging between 0.1-1000 μm.

21. The composition of claim 22, wherein at least 90% of the microcapsules having a diameter ranging from 2 to 10 μm.

22. The composition of claim 1, wherein the insecticide is selected from the group consisting of carbamates, organophosphates, cyclodiene organochlorines fiproles, neonicotinoids, spinosyns, chloride channel activators, juvenile hormone mimics, selective homopteran feeding blockers, mite growth inhibitors, inhibitors of mitochondrial ATP synthase, nicotinic acetylcholine receptor channel blockers, inhibitors of the chitin biosynthesis, moulting disruptors, ecdyson receptor agonists, octopamin receptor agonists, mitochondrial complex electron transport inhibitors, voltage-dependent sodium channel blockers, inhibitors of the lipid synthesis, ryanodine receptor-modulators, and sodium channel modulators

23. The composition of claim 22, wherein the insecticide is a pyrethroid.

24. The composition of claim 23, wherein the pyrethroid is selected from the group consisting of acrinathrin, allethrin, bifenthrin, cyfluthrin, lambda-cyhalothrin, cyper-methrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

25. The composition of claim 24, wherein the pyrethroid is bifenthrin.

26. A composition consisting essentially of (a) bifenthrin (b) Aromatic 200 ND; (c) corn oil; (d) polyisocyanate; (e) lignosulfonic acid-sodium salt, sulfomethylated; (f) acetic acid ethenyl ester polymer with ethenol; (g) xanthan gum; (h) a silicone emulsion mixture; (i) 1,3-benzisothiazol-3-one; (j) a hexamethylene diamine; (k) phosphoric acid; and (1) water.

27. The process of making a high-load insecticide microcapsule compositions comprising the steps (a) mixing agrochemical with an organic solvent, at least one monomer, and an oil to prepare an organic mixture phase (b) dissolving a sodium salt, polyvinyl alcohol, and a thickener in an aqueous solvent to form an aqueous phase, (c) homogenizing the organic phase with the aqueous phase in a homogenizer and allowing interfacial polymerization for up to at least 24 hours.

28. The process of claim 27, wherein the interfacial polymerization occurs at a temperature ranging from 25 to 65° C.

29. The process of claim 28, wherein the interfacial polymerization occurs at a temperature ranging from 45 to 60° C.

30. The process of claim 27, further comprising adjusting the viscosity of the composition to a measurement ranging from 200 and to 5000 Centipoises (mPa·s) with spindle #3, measured with Brookfield Rotational LVT Viscometers.

31. The process of claim 27, wherein the amount of insecticide encapsulated in the microcapsules are at least 8% w/w.

32. A method for protecting seeds and growing plants from pests by: (a) applying a composition to seeds, wherein the composition comprises: a plurality of microcapsules comprising a polymeric shell and a core encapsulating at least one or a combination of an pesticides, wherein the total concentration of the insecticide is in the range of 40 to about 450 grams/l.

33. A seed coating composition comprising an aqueous solution and a plurality of microcapsules wherein each one of said microcapsules comprising a core containing an insecticide containing oil phase and a polymeric shell surrounding said oil comprising at least one polymer selected from the group consisting of polyureas, polyurethanes, polyamides, and polyesters.

34. The composition of claim 33, wherein the polymer of the outer polymeric shell is polyurea.

35. The composition of claim 34, wherein the core further comprises a solvent.

36. The composition of claim 33, wherein the mean particle size (D50) of said microcapsules is 10 micrometers or less.

37. The composition of claim 33, wherein thickness of the polymeric wall ranges between 5 nm to about 20 nm.

38. A coated seed comprising a seed and a coating, wherein said coating comprising plurality of microcapsules wherein each microcapsule comprises an outer polymeric shell encapsulating a core comprising a pyrethroid.

39. The coated seed of claim 38, wherein the outer polymeric shell comprises at least one polymer selected from the group consisting of polyureas, polyurethanes, polyamides, and polyesters.

40. The coated seed of claim 39, wherein the polymer of the outer polymeric shell is polyurea.

41. The coated seed of claim 39, wherein the core further comprises a solvent and/or an oil.

42. The coated seed of claim 41, wherein the solvent is an organic solvent selected from the group consisting of petroleum (Aromatic 200 ND), or other hydrophobic solvents.

43. The coated seed of claim 39, wherein the pyrethroid is bifenthrin.

44. The coated seed of claim 43, wherein the microcapsule further comprising (a) a co-solvent; (b) effective amounts of isocyanate; (c) a dispersant; (d) polyvinyl alcohol; (e) viscosity modifying agents (f) antifoam agent (such as a silicone emulsion mixture); (g) a biocide (such as 1,3-benzisothiazol-3-one); (h) an amine; and (i) a pH modifier.
